(19) United States
(12) Patent Application Publication
(10) Pub. No.: US 2025/0371102 A1
(43) Pub. Date: Dec. 4, 2025

(54) DATA PROCESSING EQUIPMENT, DATA PROCESSING PROGRAM AND DATA PROCESSING METHOD

(71) Applicant: NIPPON TELEGRAPH AND TELEPHONE CORPORATION, Tokyo (JP)

(72) Inventors: Saki HATTA, Tokyo (JP); Ken NAKAMURA, Tokyo (JP); Hiroyuki UZAWA, Tokyo (JP); Daisuke KOBAYASHI, Tokyo (JP); Yuya OMORI, Tokyo (JP); Shuhei YOSHIDA, Tokyo (JP); Yuko IINUMA, Tokyo (JP)

(73) Assignee: NIPPON TELEGRAPH AND TELEPHONE CORPORATION, Tokyo (JP)

(21) Appl. No.: 18/874,024

(22) PCT Filed: Jun. 20, 2022
(86) PCT No.: PCT/JP2022/024588

§ 371 Date: Dec. 11, 2024

(51) Int. Cl. G06F 17/15; G06F 7/544

(52) U.S. Cl. CPC G06F 17/15; G06F 7/5443

(57) ABSTRACT

A data processing equipment 1 performs a convolution operation on two items of input data having a width of 2^{M}* N-bit, where N is a positive integer and M is an integer of 0 or more, with a minimum accuracy of a convolution operation being N bits, in a case of performing processing corresponding to a plurality of the Ms that are consecutive, performs a product-sum operation of the minimum accuracy, in a case in which a value of the M is not 0, performs shift processing on an operation result of a product-sum operation of the minimum accuracy and performs an operation of a sign in a convolution operation of the input data, reflects a sign held until a reset signal is received in an output of the shift processing according to a value of the M, and cumulatively adds an output of the shift processing in which a sign is reflecte.

### TECHNICAL FIELD

The disclosed technology relates to a data processing equipment that performs a convolution operation, a data processing program, and a data processing method.

### BACKGROUND ART

A convolutional neural network (CNN) is mainly used for image recognition, and includes a “convolution layer” that performs a convolution operation to extract a feature amount of an input image. In recent years, You Only Look Once (YOLO), which is an object detection algorithm based on a CNN, a pose estimation algorithm OpenPose, and the like have been disclosed (Non Patent Literature 1 and 2), and application to an edge AI system requiring real-time performance such as a monitoring camera installed in automatic driving or a drone has been studied. It is assumed that these systems require different convolution operation accuracy for each application, and implementing size reduction while including a mechanism capable of switching the accuracy in one system is an issue.

Therefore, for example, Non Patent Literature 3 discloses a processing method for implementing three types of convolution operation accuracy of 4 bits, 8 bits, and 16 bits by a shared circuit.

### CITATION LIST

### Patent Literature

(Non Patent Literature 1)
Joseph Redmon, Ali Farhadi, “YOLOv3: An Incremental Improvement”, <URL: https://arxiv.org/abs/1804.02767>
(Non Patent Literature 2)

Zhe Cao et al., “Realtime Multi-Person 2D Pose Estimation using Part Affinity Fields”, <URL: https://arxiv.org/pdf/1611.08050.pdf>
(Non Patent Literature 3)

Hao Zhang et al., “New Flexible Multiple-Precision Multilpy-Accumulate Unit for Deep Neural Network Training and Inference”

### SUMMARY OF INVENTION

### Technical Problem

FIG. 12 is a diagram illustrating a conventional general three-dimensional convolution operation method. In a certain layer of a network model, a product-sum operation of each kernel for n channels as a weight for extracting a feature of an input feature map (iFmap) is performed on the input feature map of n channels in a case where the number of input channels is n (integer of n>0). In a case where the number of output channels is m (integer of m>0), an output feature map (oFmap) of m channels is generated by repeating the product-sum operation for m channels. The obtained oFmap of m channels is the iFmap of the next layer. Note that the first layer is not an iFmap but input video data, and the input channels are generally three channels of RGB. In a case where the above processing is implemented by general hardware, when design is made in which an iFmap is read from a memory stored in one cycle, the memory and the wiring are designed according to the data amount of the largest size (x and y in which x * y in FIG. 12 is maximum) throughout, and the circuit scale increases. In order to avoid an increase in circuit scale, a method is adopted in which the maximum value of an iFmap is divided into several blocks, the iFmap is input for each of the blocks, a convolution operation is performed, and output is performed.

FIG. 13 is a diagram illustrating a processing method in units of one pixel using the technology disclosed in Non Patent Literature 3. As a product-sum operation circuit that performs a convolution operation, a product-sum operation circuit that supports the maximum value (for example, 16 bits) of the operation mode is prepared, and even in a case where a convolution operation is performed in an 8-bit mode and a 4-bit mode, the same product-sum operation circuit is used so that a circuit for each mode does not need to be individually included. In FIG. 13, black circles indicate a state where an 8-bit product-sum operation unit is used, and white circles indicate a state where an 8-bit product-sum operation unit is not used.

In a case of a 16-bit mode, a product-sum operation of an input pixel block (blk_1, 1 is a block number, 1>0) obtained by dividing an iFmap into a plurality of parts and a kernel is executed using all operation units, and stored in a cumulative storage memory as an intermediate result of the oFmap. This processing is repeated and cumulatively added by the number of blocks and the number of input channels (iCH_n, n is the maximum input channel) according to the size of the iFmap to generate an oFmap corresponding to output channels (OCH_m, m is the maximum output channel).

In a case of the 8-bit mode, the double number of blocks are input (two pixels when focusing on one pixel), and two processes are executed in parallel to double the processing speed. Similarly, in the 4-bit mode, a processing method in which four processes are executed in parallel is adopted.

However, in Non Patent Literature 3, a processing method is adopted in which a product-sum operation circuit needs to be prepared in accordance with the most accurate (16 bits in the above example) operation mode prepared in advance, and thus the use efficiency of both the logic and the memory deteriorates in a case of use in an operation mode of lower accuracy than the most accurate operation mode than in a case of use in the most accurate operation mode. Furthermore, convolution operation processing occupies most of AI inference processing, and in a case where hardware capable of supporting the most accurate operation mode is prepared, there is an issue that a circuit area is overwhelmingly large as compared with a case where hardware is prepared in accordance with other operation modes.

The disclosed technology has been made in view of the above points, and an object thereof is to provide a data processing equipment, a data processing program, and a data processing method capable of efficiently performing combined processing of the most accurate operation mode and other operation modes even in a case where minimum necessary hardware is used instead of hardware according to the most accurate operation mode that can be supported.

### Solution to Problem

A first aspect of the present disclosure is data processing equipment that performs a convolution operation on two items of input data having a width of 2^{M}* N-bit, whereN is a positive integer and M is an integer of 0 or more, with a minimum accuracy of a convolution operation being N bits, and performs processing corresponding to a plurality of the Ms that are consecutive, and the data processing equipment includes a product-sum operation unit that performs a product-sum operation of the minimum accuracy, a shifter that performs shift processing on an operation result of a product-sum operation in the product-sum operation unit in a case in which a value of the M is not 0, a sign operation unit that performs an operation of a sign in a convolution operation of the input data in a case in which a value of the M is not 0, a sign holding unit that holds a sign operated by the sign operation unit until a reset signal of which notice is given every time a convolution operation of the input data is ended is received, and reflects a held sign in an output of the shifter according to a value of the M, a cumulative addition unit that cumulatively adds an output of the shifter in which a sign is reflected by the sign holding unit, and a cumulative storage memory that stores an operation result of cumulative addition output from the cumulative addition unit in a process of a convolution operation.

A second aspect of the present disclosure is a data processing program for causing performance of a convolution operation on two items of input data having a width of 2^{M}* N-bit, where N is a positive integer and M is an integer of 0 or more, with a minimum accuracy of a convolution operation being N bits, and causing execution of processing corresponding to a plurality of the Ms that are consecutive, and the data processing program executable by a computer to perform processing comprising performing a product-sum operation of the minimum accuracy, performing shift processing on an operation result of a product-sum operation of the minimum accuracy in a case in which a value of the M is not 0, performing an operation of a sign in a convolution operation of the input data in a case in which a value of the M is not 0, holding an operated sign until a reset signal of which notice is given every time a convolution operation of the input data is ended is received, and reflecting a held sign in an output of the shift processing according to a value of the M, cumulatively adding an output of the shift processing in which a sign is reflected, and storing an operation result of cumulative addition acquired in a process of a convolution operation.

A third aspect of the present disclosure is a data processing method of performing a convolution operation on two items of input data having a width of 2^{M}* N-bit, whereN is a positive integer and M is an integer of 0 or more, with a minimum accuracy of a convolution operation being N bits, and performing processing corresponding to a plurality of the Ms that are consecutive, the method comprising a computer executing processing comprising: performing a product-sum operation of the minimum accuracy, performing shift processing on an operation result of a product-sum operation of the minimum accuracy in a case in which a value of the M is not 0, performing an operation of a sign in a convolution operation of the input data in a case in which a value of the M is not 0, holding an operated sign until a reset signal of which notice is given every time a convolution operation of the input data is ended is received, and reflecting a held sign in an output of the shift processing according to a value of the M, cumulatively adding an output of the shift processing in which a sign is reflected, and storing an operation result of cumulative addition acquired in a process of a convolution operation.

### Advantageous Effects of Invention

According to a data processing equipment, a data processing program, and a data processing method of the present disclosure, there is an effect that combined processing of the most accurate operation mode and other operation modes can be efficiently performed even in a case where the minimum necessary hardware is used instead of hardware according to the most accurate operation mode that can be supported.

### BRIEF DESCRIPTION OF DRAWINGS

FIG. 1 is a schematic diagram illustrating a data processing method in a 16-bit mode of a data processing equipment according to a first embodiment.

FIG. 2 is a diagram illustrating a reflection example of a sign in a 16-bit mode of the data processing equipment according to the first embodiment.

FIG. 3 is a diagram illustrating a functional configuration example of the data processing equipment according to the first embodiment.

FIG. 4 is a block diagram illustrating a hardware configuration example of the data processing equipment according to the first embodiment.

FIG. 5 is a flowchart illustrating an example of a flow of convolution operation processing in the 16-bit mode according to the first embodiment.

FIG. 6 is a flowchart illustrating an example of a flow of convolution operation processing in an 8-bit mode according to the first embodiment.

FIG. 7 is a schematic diagram illustrating a data processing method in a 4-bit mode of a data processing equipment according to a second embodiment.

FIG. 8 is a schematic diagram illustrating a data processing method in an 8-bit mode of a data processing equipment according to a second embodiment.

FIG. 9 is a diagram illustrating a functional configuration example of the data processing equipment according to the second embodiment.

FIG. 10 is a flowchart illustrating an example of a flow of convolution operation processing in the 4-bit mode according to the second embodiment.

FIG. 11 is a flowchart illustrating an example of a flow of convolution operation processing in the 8-bit mode according to the second embodiment.

FIG. 12 is a schematic diagram illustrating a conventional general three-dimensional convolution operation method.

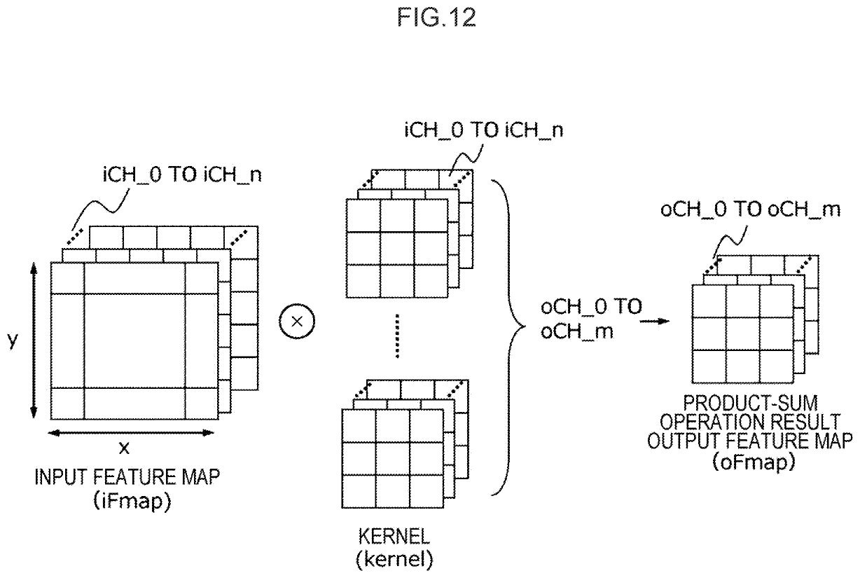

FIG. 13 is a schematic diagram illustrating a convolution operation method using a product-sum arithmetic circuit that supports the processable maximum accuracy.

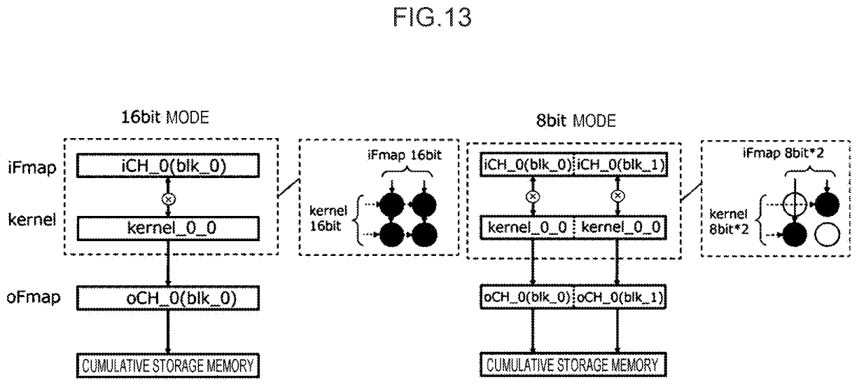

### DESCRIPTION OF EMBODIMENTS

Hereinafter, examples of embodiments according to the disclosed technology will be described with reference to the drawings. Note that the same or equivalent components, parts, and processing are denoted by the same reference signs throughout the drawings, and redundant description will be omitted.

### First Embodiment

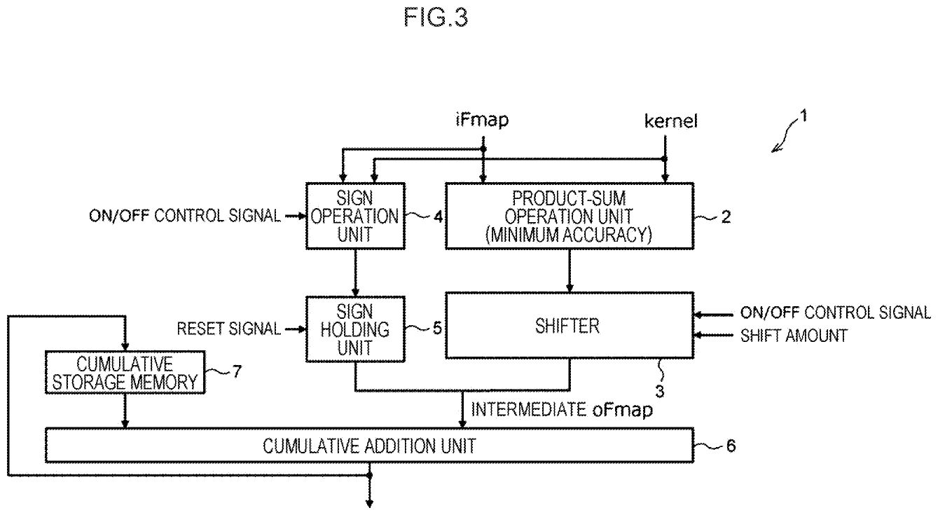

In a first embodiment, a data processing equipment 1 (see FIG. 3) that includes operation units that support the lowest accuracy among plurality of types of convolution operation accuracy that can be supported (hereinafter, the operation units are referred to as “minimum accuracy operation units”) and implements a convolution operation corresponding to each of the types of convolution operation accuracy by combining the minimum accuracy operation units will be described. For convenience of description, among convolution operations of a plurality of types of accuracy that can be supported in the data processing equipment 1, a convolution operation of the lowest operation accuracy is referred to as a convolution operation of the “minimum accuracy”, and a convolution operation of operation accuracy higher than the minimum accuracy is referred to as a convolution operation of “high accuracy”. The data processing equipment 1 divides an input operation target parameter into two pieces of data of an upper bit and a lower bit both having the same bit width, and operates the upper bit and the lower bit in a time division manner, thereby implementing a convolution operation of high accuracy.

The data processing method according to the first embodiment is a technology capable of supporting a plurality of types of convolution operation accuracy defined by any continuous index M among two pieces of input data having a 2^{M}* N-bit (index M is an integer of 0 or more) width when the minimum accuracy of a convolution operation of an iFmap and a kernel is N bits (N>0, N is an integer). However, here, as an example, description will be given of a data processing method and a configuration of the data processing equipment 1 in a case where the minimum accuracy is represented by N=8 and the index is represented by M=0, 1, that is, the input data is represented by 8 bits and 16 bits.

### Data Processing Method in 16-Bit Mode

First, a data processing method in a 16-bit mode using an 8-bit operation unit will be described. Assuming that the upper 8 bits and the lower 8 bits of a 16-bit iFmap are “x” and “y”, respectively, the upper 8 bits and the lower 8 bits of a 16-bit kernel are “a” and “b”, respectively, and an operator representing multiplication is “*”, iFmap * kernel is expressed as in Formula (1). Note that “\hat{ }” is an operator representing a power.

$$\begin{matrix}( Math . 1 ) & \\ \begin{matrix}iFmap * kernel = \{ 256 * x + y \} * \{ 256 * a + b \} \\ = 256 \hat{} 2 * ax + 256 * ( ay + bx ) + by\end{matrix} & ( 1 )\end{matrix}$$

According to Formula (1), it is indicated that multiplication of 16-bit data can be implemented using an 8-bit operation unit by performing a left shift operation to shift ax to the left by about 16 bits, performing a left shift operation to shift each of ay and bx to the left by about 8 bits, and adding by to each shift operation result. Processing of performing a bit shift operation on a certain value in this manner is referred to as shift processing.

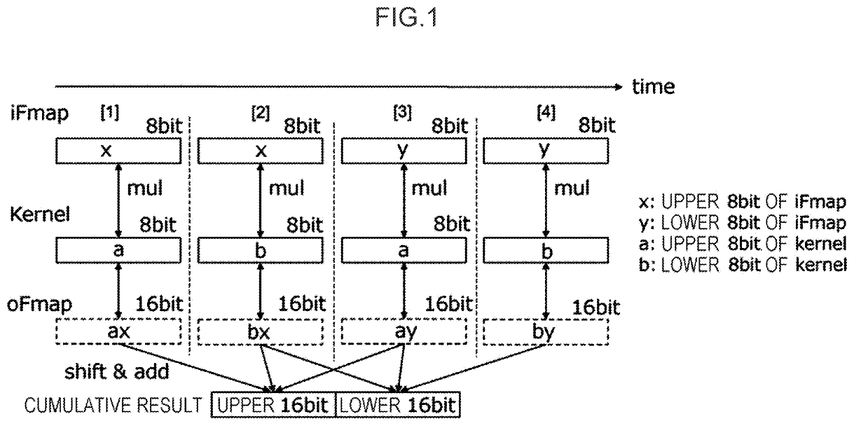

FIG. 1 is a schematic diagram of a data processing method in a 16-bit mode using an 8-bit operation unit illustrated in Formula (1). In FIG. 1, an 8-bit operation of each term is performed in the order from the left to the right, that is, the order of an operation [1]→an operation [2]→an operation [3]→an operation [4]. The operation [1] represents an operation of a term of 256\hat{ }2* ax, the operation [2] represents an operation of a term of 256* bx, the operation [3] represents an operation of a term of 256* ay, and the operation [4] represents an operation of a term of by. Note that, in FIG. 1, multiplication is represented by “mul”. As described above, in order to clearly indicate that it is multiplication processing, multiplication may be represented by “mul” and “x” as necessary in each drawing.

First, the data processing equipment 1 performs multiplication on the upper 8 bits of an iFmap and a kernel, and stores a value obtained by shifting the multiplication result to the left by about 16 bits in a memory as a cumulative result (FIG. 1: operation [1]).

Since data with a sign is generally operated in a convolution operation, the data processing equipment 1 holds a sign determined by the operation [1] until processing of the operation [4] is ended, and performs an operation of only a numerical value without being conscious of the sign in the remaining operations [2] to [4].

After the operation [1], the data processing equipment 1 multiplies the upper 8 bits of the iFmap by the lower 8 bits of the kernel and multiplies the lower 8 bits of the iFmap by the upper 8 bits of the kernel, adds a value obtained by shifting each multiplication result to the left by about 8 bits to the previous operation result, and stores the result in the memory (FIG. 1: operation [2], operation [3]).

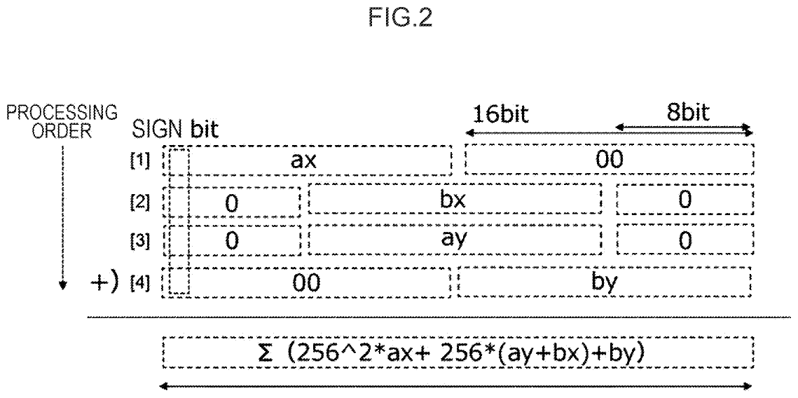

Finally, the data processing equipment 1 adds the multiplication result of the lower 8 bits of the iFmap and the lower 8 bits of the kernel to operation results of the operations [1] to [3] (FIG. 1: operation [4]), and reflects the sign determined in the operation [1] in the cumulative result of the operations [1] to [4], thereby obtaining a final cumulative result as illustrated in FIG. 2.

The data processing equipment 1 obtains an oFmap by repeating the operations [1] to [4] for all pixels of the iFmap for the number of all input channels iCH_n. Note that the operation [1] needs to be performed first so that the sign is determined, but the order of the operations [2] to [4] may be changed.

According to the data processing method of the present disclosure, since a sign of a cumulative result is determined by processing of the upper 8 bits of both an iFmap and a kernel in the operation [1], a sign bit does not need to be newly input in the operations [2] to [4]. Since data having a 1-bit width representing a sign does not need to be held accordingly, the bit width of the operation units can be reduced by 1 bit.

Note that, in the data processing method of the disclosure, an example has been described in which an operation is performed for each pixel and each input channel iCH in an operation of each term of the operations [1] to [4], but the data processing method is not limited thereto. For example, the data processing equipment 1 may process a plurality of pixels in parallel in the same input channel iCH, or may process pixels included in different input channels iCH in parallel.

### Data Processing Method in 8-Bit Mode

Next, a data processing method in an 8-bit mode using an 8-bit operation unit will be described. In the 8-bit mode, since input data can be directly input to the 8-bit operation unit, the data processing equipment 1 executes an operation by the 8-bit operation unit without dividing the input data into upper bits and lower bits as in the 16-bit mode. That is, the data processing equipment 1 multiplies an 8-bit iFmap by an 8-bit kernel, and adds each multiplication result without performing bit shift, thereby obtaining a cumulative result. In this case, since an operation of input data of 16 bits does not need to be performed in four times as in the 16-bit mode, the processing performance of the data processing equipment 1 is four times the processing performance in the 16-bit mode.

FIG. 3 is a diagram illustrating a functional configuration example of the data processing equipment 1. As illustrated in FIG. 3, the data processing equipment 1 includes functional units of a product-sum operation unit 2, a shifter 3, a sign operation unit 4, a sign holding unit 5, a cumulative addition unit 6, and a cumulative storage memory 7.

The product-sum operation unit 2 receives an iFmap and a kernel, and performs a product-sum operation of the minimum accuracy.

In a case where the value of the index M is not 0, that is, a case where the operation mode is high accuracy, the shifter 3 performs shift processing on an operation result of the product-sum operation unit 2.

The cumulative storage memory 7 stores a cumulative addition of an intermediate oFmap obtained in the process of a convolution operation performed by the product-sum operation unit 2 and the shifter 3. The “intermediate oFmap” is an intermediate result of the oFmap obtained in the process of a convolution operation.

In a case where the operation mode is high accuracy, the sign operation unit 4 performs an operation of a sign by a convolution operation performed by the product-sum operation unit 2 and the shifter 3.

The sign holding unit 5 holds a sign operated by the sign operation unit 4 until a reset signal of which notice is given every time a convolution operation of an iFmap and a kernel is ended is received, and reflects the held sign in an output of the shifter 3 according to the value of the index M.

The cumulative addition unit 6 adds an intermediate oFmap obtained in the process of a convolution operation performed by the product-sum operation unit 2 and the shifter 3 and in which the sign is reflected by the sign holding unit 5 to a cumulative addition result so far stored in the cumulative storage memory 7, and updates a cumulative addition of the intermediate oFmap.

The operation of the shifter 3 and the sign operation unit 4 is changed by, for example, an ON/OFF control signal set according to the operation mode.

Specifically, in a case of the 8-bit mode, which is the minimum accuracy for the data processing equipment 1, the value of the ON/OFF control signal is set to OFF. In a case where the value of the ON/OFF control signal is set to OFF, the shifter 3 outputs an operation result of the product-sum operation unit 2 to the cumulative addition unit 6 as it is without performing shift processing. In a case where the value of the ON/OFF control signal is set to OFF, the sign operation unit 4 does not perform an operation of a sign.

On the other hand, in a case of the 16-bit mode, which is an operation mode of high accuracy for the data processing equipment 1, the value of the ON/OFF control signal is set to ON. In a case where the value of the ON/OFF control signal is set to ON, the shifter 3 performs shift processing on an operation result of the product-sum operation unit 2. The shift amount in the shift processing is set depending on which one of the operations [1] to [4] illustrated in FIG. 1 is being performed. The sign operation unit 4 receives an ON/OFF control signal including a value set to ON every time the operation [1] is performed. In a case where the value of the ON/OFF control signal is set to ON, the sign operation unit 4 calculates a sign using the most significant bit of each of the iFmap and the kernel input while the value of the ON/OFF control signal is ON, and outputs the sign to the sign holding unit 5.

Thereafter, when the operation [4] illustrated in FIG. 1 is ended in the data processing equipment 1, a reset signal is input to the sign holding unit 5. The sign holding unit 5 reflects the held sign in an operation result output from the shifter 3 and outputs the result to the cumulative addition unit 6 until a reset signal is input. That is, in a case where the data processing equipment 1 operates in the 16-bit mode, every time the product-sum operation unit 2 performs a product-sum operation four times, a reset signal is input to the sign holding unit 5, and a sign held in the sign holding unit 5 is reset.

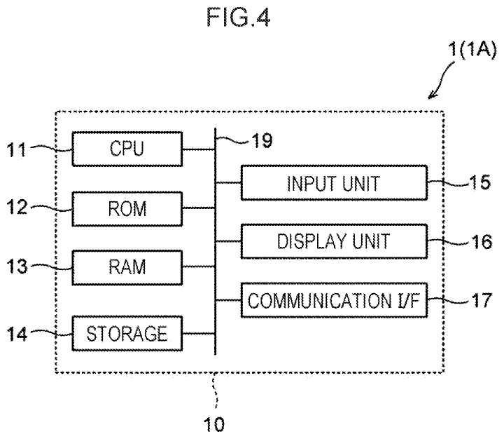

Next, a hardware configuration example of the data processing equipment 1 according to the first embodiment of the present disclosure will be described. FIG. 4 is a block diagram illustrating a hardware configuration example of the data processing equipment 1. As illustrated in FIG. 4, the data processing equipment 1 is formed using a computer 10, and includes a central processing unit (CPU) 11, a read only memory (ROM) 12, a random access memory (RAM) 13, a storage 14, an input unit 15, a display unit 16, and a communication interface (I/F) 17. The components are communicably connected with each other via a bus 19.

The CPU 11 is a central processing unit that is an example of a processor, and executes a program and controls each unit. That is, the CPU 11 reads a program from the ROM 12 or the storage 14, and executes the program using the RAM 13 as a working area. The CPU 11 controls each functional unit illustrated in FIG. 3 and performs various types of operation processing according to the program stored in the ROM 12 or the storage 14. As an example, in the first embodiment, the ROM 12 or the storage 14 stores a data processing program for executing convolution operation processing.

The ROM 12 stores various programs and various types of data. The RAM 13, as a work area, temporarily stores programs or data. The storage 14 includes a storage equipment such as a hard disk drive (HDD) or solid state drive (SSD) and stores various programs including an operating system and various types of data.

The input unit 15 includes a pointing equipment such as a mouse and a keyboard and is used to perform various inputs.

The display unit 16 is, for example, a liquid crystal display, and displays various types of information. The display unit 16 may function as the input unit 15 by employing a touch panel system.

The communication I/F 17 is an interface for communicating with other devices. For the communication, for example, a wired communication standard such as Ethernet (registered trademark) or fiber distributed data interface (FDDI) or a wireless communication standard such as 4G, 5G, or Wi-Fi (registered trademark) is used.

Note that the input unit 15, the display unit 16, and the communication I/F 17 may not necessarily be included in the computer 10 depending on the situation.

Next, the operation of the data processing equipment 1 according to the first embodiment will be described.

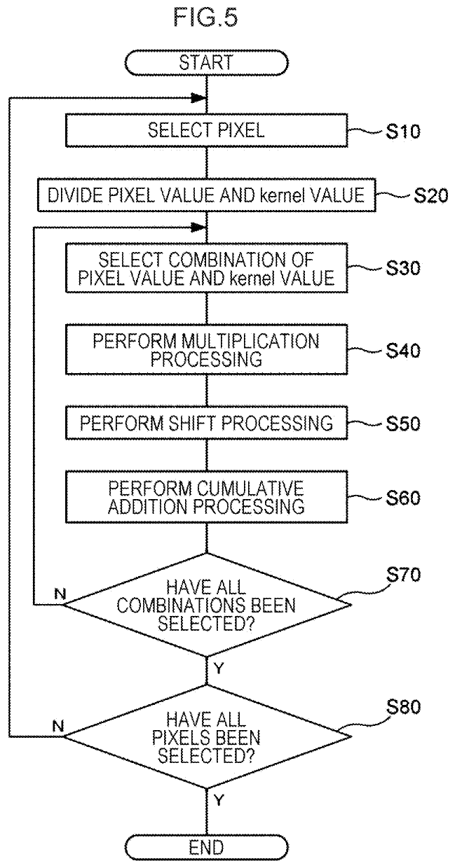

FIG. 5 is a flowchart illustrating an example of a flow of convolution operation processing executed by the CPU 11 of the data processing equipment 1 in the 16-bit mode.

The data processing program defining the convolution operation processing is stored in advance in, for example, the ROM 12 of the data processing equipment 1. The CPU 11 of the data processing equipment 1 reads the data processing program stored in the ROM 12 and executes convolution operation processing. Note that the CPU 11 initializes a cumulative addition value stored, for example, in the RAM 13 to “0” before executing the convolution operation processing.

When an iFmap and kernels of any one of input channels iCH_n are input, in step S10, the CPU 11 selects any one pixel included in the iFmap, and acquires a pixel value of the pixel selected from the iFmap and a kernel value of a kernel corresponding to the pixel selected from the iFmap. Both the pixel value acquired from the iFmap and the kernel value acquired from the kernel are represented by 16 bits. For convenience of description, a value of the selected pixel of the iFmap is referred to as a “selected pixel value”.

In step S20, the CPU 11 divides the selected pixel value into upper 8 bits and lower 8 bits, and also divides the kernel value into upper 8 bits and lower 8 bits. The upper 8 bits and the lower 8 bits of the divided selected pixel value correspond to “x” and “y” indicated in Formula (1), respectively. The upper 8 bits and the lower 8 bits of the divided kernel value correspond to “a” and “b” indicated in Formula (1), respectively.

In step S30, the CPU 11 selects any one combination of combinations of the selected pixel value “x” and the kernel value “a”, the selected pixel value “x” and the kernel value “b”, the selected pixel value “y” and the kernel value “a”, and the selected pixel value “y” and the kernel value “b” each obtained by dividing according to Formula (1). Provided that, in order to determine the sign of an operation result, the CPU 11 selects the combination of the selected pixel value “x” and the kernel value “a” in a first selection.

In step S40, the CPU 11 executes multiplication processing of multiplying the combination selected in step S30. Note that, in a case where the combination of the selected pixel value “x” and the kernel value “a” is selected in step S30, the CPU 11 stores a sign of a multiplication result in the RAM 13.

In step S50, the CPU 11 executes shift processing of performing a left shift operation on the multiplication result of step S40 by a shift amount uniquely determined from Formula (1) for the combination of the selected pixel value and the kernel value each obtained by dividing.

In step S60, the CPU 11 reflects the sign stored in the RAM 13 in step S40 in the operation result in step S50, and executes cumulative addition processing of adding the operation result in which the sign is reflected to a cumulative addition value.

In step S70, the CPU 11 determines whether all combinations of a selected pixel value and a kernel value based on Formula (1) are selected. In a case where there is an unselected combination, the processing proceeds to step S30, any one of unselected combinations is selected, and processing of steps S30 to S70 is repeatedly executed until all the combinations are selected. As described above, in a case of input data having a 16-bit width, the processing in steps S30 to S70 is repeated four times for each pixel included in the iFmap. On the other hand, in a case where all the combinations are selected, the processing proceeds to step S80. In this case, the CPU 11 deletes the sign stored in the RAM 13 in step S40 and resets a sign.

In step S80, the CPU 11 determines whether all pixels included in the input iFmap have been selected. In a case where an unselected pixel is included in the iFmap, the processing proceeds to step S10, any one of unselected pixels is selected, and processing of steps S10 to S80 is repeatedly executed until all the pixels are selected. On the other hand, in a case where all the pixels included in the iFmap are selected, the convolution operation processing in the 16-bit mode illustrated in FIG. 5 is ended.

As described above, the convolution operation of the iFmap and the kernels of one channel is completed, and a cumulative addition value obtained by convolution operations is stored in the RAM 13 as a pixel value of an oFmap. In a case where there are n channels of the iFmap, the CPU 11 may repeatedly execute the convolution operation processing illustrated in FIG. 5 by the number of input channels.

Since time division processing is performed in the convolution operation processing in the 16-bit mode, the processing performance is ½ as compared with the conventional convolution operation processing indicated in Non Patent Literature 3, but since only one 8-bit operation unit is required, the area of hardware resources related to the operation unit is ¼.

Note that, in the convolution operation processing illustrated in FIG. 5, the CPU 11 receives input data such as an iFmap and kernels, and then divides the input data according to the minimum accuracy of the operation unit (see step S20 in FIG. 5), but there is no restriction on the division timing of the input data. For example, the CPU 11 may divide a pixel value into bit widths of the minimum accuracy before storing the pixel value of an oFmap in the RAM 13.

The convolution operation processing of the data processing equipment 1 in the 16-bit mode has been described in FIG. 5, and convolution operation processing of the data processing equipment 1 in the 8-bit mode will be described next.

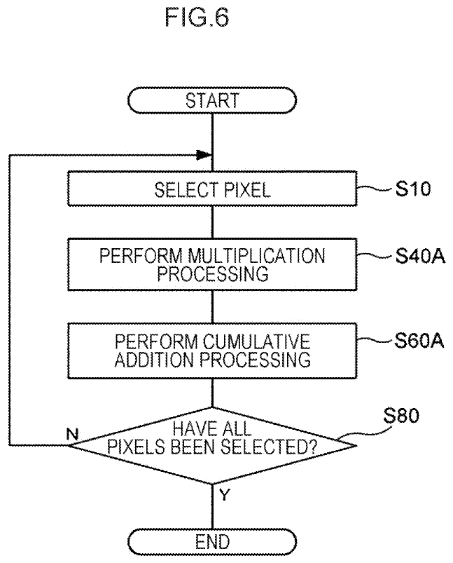

FIG. 6 is a flowchart illustrating an example of a flow of convolution operation processing executed by the CPU 11 of the data processing equipment 1 in the 8-bit mode. The flowchart illustrated in FIG. 6 is different from the flowchart illustrated in FIG. 5 in that steps S20, S30, S50, and S70 are deleted, and steps S40 and S60 are replaced with steps S40A and S60A, respectively. Note that the CPU 11 initializes a cumulative addition value to “0” before executing the convolution operation processing, similarly to the convolution operation processing in the 16-bit mode.

When an iFmap and kernels of any one of input channels iCH_n are input, in step S10, the CPU 11 selects any one pixel included in the iFmap, and acquires a pixel value of the pixel selected from the iFmap and a kernel value of a kernel corresponding to the pixel selected from the iFmap. Both the selected pixel value and the value of the kernel are represented by 8 bits.

In step S40A, the CPU 11 executes multiplication processing of multiplying the selected pixel value by the kernel value.

In step S60A, the CPU 11 executes cumulative addition processing of adding the multiplication result obtained in step S40A to a cumulative addition value.

In step S80, the CPU 11 determines whether all pixels included in the input iFmap have been selected. In a case where an unselected pixel is included in the iFmap, the processing proceeds to step S10, any one of unselected pixels is selected, and processing of steps S10 to S80 is repeatedly executed until all the pixels are selected. On the other hand, in a case where all the pixels included in the iFmap are selected, the convolution operation processing in the 8-bit mode illustrated in FIG. 6 is ended. As described above, in a case of input data having an 8-bit width, processing in steps S40A and S60A is performed only once for each pixel included in the iFmap.

In the first embodiment, an example of the convolution operation processing of the data processing equipment 1 in the 8-bit mode and the 16-bit mode has been described, but the bit width of input data that can be supported by the data processing equipment 1 is not limited to two of 8 bits and 16 bits. The data processing equipment 1 can also perform the convolution operation processing on input data having a plurality of other bit widths of, for example, 4 bits, 8 bits, and 16 bits. In this case, since the minimum accuracy is 4 bits, the data processing equipment 1 performs the convolution operation processing using a 4-bit operation unit.

In a case of using the 4-bit operation unit, the data processing equipment 1 may perform the convolution operation processing of supported accuracy by dividing input data having an 8-bit width and input data having a 16-bit width into input data having a 4-bit width and performing the time division processing described so far on the data obtained by dividing. Specifically, the data processing equipment 1 repeats a product-sum operation once in the 4-bit mode, four times in the 8-bit mode, and 16 times in the 16-bit mode, so that a 4-bit operation, an 8-bit operation, and a 16-bit operation can be implemented, respectively.

As described above, according to the data processing equipment 1 according to the first embodiment, combined processing of highly accurate operation modes can be efficiently performed even in a case where hardware resources according to the operation accuracy of the minimum accuracy among operation accuracy that can be supported are used.

### Second Embodiment

In the first embodiment, an example has been described in which an operation mode of high accuracy is implemented by dividing input data according to the minimum accuracy using the minimum accuracy as a reference and time division processing of the divided input data. However, in a case where an operation mode of higher accuracy using an operation mode of the minimum accuracy as a reference is implemented, the processing performance tends to deteriorate as the accuracy of the operation mode is higher. For example, in a case of three operation modes of 4 bits, 8 bits, and 16 bits, the processing performance is ¼ in the 8-bit mode and 1/16 in the 16-bit mode as compared with the processing performance of the 4-bit mode, which is the minimum accuracy.

In a second embodiment, a data processing equipment 1A that performs convolution operation processing using the time division processing illustrated in the first embodiment only in an operation mode of higher accuracy than operation accuracy serving as a reference using an operation mode of another type of accuracy as a reference instead of using an operation mode of the minimum accuracy as a reference will be described. Hereinafter, the operation accuracy serving as a preset reference is referred to as “reference accuracy”.

Similarly to the data processing method according to the first embodiment, a data processing method according to the second embodiment is a technology capable of supporting a plurality of types of convolution operation accuracy defined by any continuous index M among two pieces of input data having a 2^{M}*N-bit width when the minimum accuracy of a convolution operation of an iFmap and a kernel is N bits. However, here, as an example, description will be given of the data processing method and a configuration of the data processing equipment 1A in a case where the minimum accuracy is represented by N=4 and the index is represented by M=0, 1, 2, that is, the input data is represented by 4 bits, 8 bits, and 16 bits. In the data processing equipment 1A, the minimum accuracy is 4 bits, and the reference accuracy is 8 bits. That is, the minimum granularity of an operation unit in the data processing equipment 1A is a 4-bit operation unit, but the data processing equipment 1A has a configuration capable of an 8-bit operation as hardware resources.

### Data Processing Method in 4-Bit Mode

First, a 4-bit mode data processing method in a case where the reference accuracy is 8 bits will be described.

As described above, the operation unit of the data processing equipment 1A is a 4-bit operation unit, but the data processing equipment 1A has hardware resources capable of an 8-bit operation. Therefore, in a case of the 4-bit mode, the data processing equipment 1A can output operation results for two channels in parallel while processing input data of two channels in parallel, as in an input channel iCH*2 and an output channel oCH*2.

In order to operate output channels oCH in parallel, the amount of supplied kernels needs to be doubled as compared with a case of operating an output channel oCH of one channel, but since input channels iCH are parallel and the bit width is half, there is no difference from processing in a case where the input bus width of an iFmap is 8 bits.

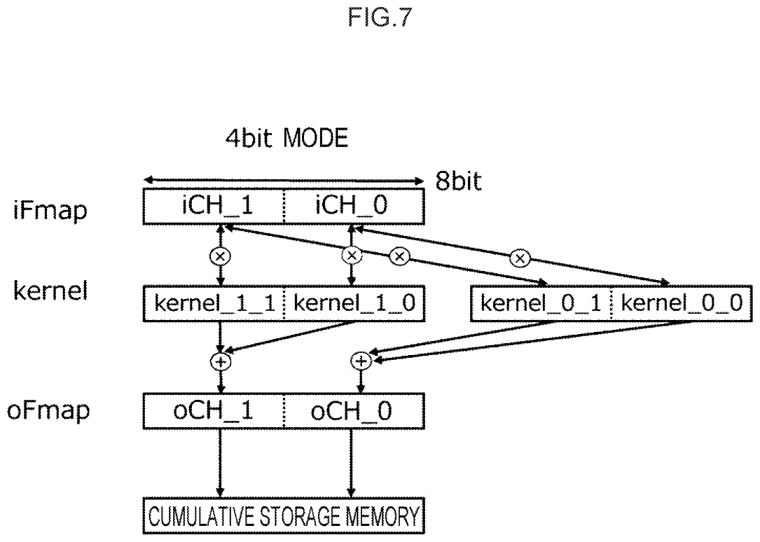

On the basis of the above content, data processing method of the 4-bit mode in the data processing equipment 1A will be specifically described with reference to FIG. 7.

In order to input an iFmap of input channels iCH of two channels (for example, iCH_0 and iCH_1) in parallel, in FIG. 7, the iFmap of the odd-numbered input channel iCH_1 is set to the upper 4 bits and the iFmap of the even-numbered input channel iCH_0 is set to the lower 4 bits for an input having an 8-bit width that is the reference accuracy.

The data processing equipment 1A sets a kernel_o_i corresponding to each of the input channel iCH_0 and the output channel oCH_0 and the input channel iCH_1 and the output channel oCH_1, and multiplies the kernel_o_i by the iFmap of the input channel iCH_0 and the kernel_o_i by the iFmap of the output channel oCH_0. Here, “o” of the kernel_o_i is the number of the output channel oCH, “i” is the number of the input channel iCH, and o and i are positive integers. Note that specific examples of the kernel corresponding to an input channel iCH_0 and an output channel oCH_0 include a kernel_0_0, a kernel_1_0, a kernel_0_1, and a kernel_1_1.

After ending multiplication of the kernel_o_i by the iFmap of the input channel iCH_0 and multiplication of the kernel_o_i by the iFmap of the output channel oCH_0, the data processing equipment 1A adds a multiplication result for each output channel oCH. Specifically, the data processing equipment 1A adds terms of multiplication results with a kernel_o_i having the same number of the output channel oCH, as in “iCH_0*kernel_0_0+iCH_1*kernel_0_1” and “ICH 0* kernel_1_0+iCH 1*kernel_1_1”.

Then, the data processing equipment 1A cumulatively adds addition values of multiplication results for each output channel oCH, and stores the results in the cumulative storage memory as intermediate results of an oFmap of the output channel oCH_0 and an oFmap of the output channel oCH_1.

By the product-sum operation described above being repeatedly executed for each pixel included in the iFmap, a final oFmap of the output channel oCH_0 and a final oFmap of the output channel oCH_1 are obtained. Furthermore, by the product-sum operation being repeated for output channels oCH_m, an oFmap in all the output channels OCH is obtained.

In such a product-sum operation, four 4-bit operation units corresponding to input channels iCH of two channels and output channels OCH of two channels are required, and the four 4-bit operation units can be used in parallel since the reference accuracy is 8 bits.

### Data Processing Method in 8-Bit Mode

Next, an 8-bit mode data processing method using a 4-bit operation unit in a case where the reference accuracy is 8 bits will be described.

In a case of the 8-bit mode, similarly to the [Data Processing Method in 16-Bit Mode] described in the first embodiment, the data processing equipment 1A divides 8-bit input data of an iFmap[7:0] and a kernel[7:0] into input data of the upper 4 bits (iFmap[7:4] and kernel[7:4]) and input data of the lower 4 bits (iFmap[3:0] and kernel[3:0]), and performs multiplication of iFmap[7:0] * kernel[7:0]. “[p:q]” is a symbol representing a range from the q-th bit (q≥0, q is an integer) to the p-th bit (p>q, p is an integer). Therefore, for example, iFmap[7:0] represents 8 bits from the 0th bit to the 7th bit of the iFmap.

Note that the principle by which iFmap[7:0] * kernel[7:0] can be operated by dividing the iFmap[7:0] and the kernel[7:0] into the iFmap[7:4], the kernel[7:4], the iFmap[3:0], and the kernel[3:0] is as described in the first embodiment. Therefore, when the iFmap[7:4] is represented as iCH(h), the iFmap[3:0] is represented as iCH(1), the kernel[7:4] is represented as kernel(h), and the kernel[3:0] is represented as kernel(1), iFmap[7:0] * kernel[7:0] is represented as in Formula (2).

$$\begin{matrix}( Math . 2 ) & \\ iFmap [ 7 : 0 ] * kernel [ 7 : 0 ] = 2 \hat{} 8 \hat{} 2 * iCH ( h ) * kernel ( h ) + 2 \hat{} 8 * ( iCH ( h ) * kernel ( l ) + iCH ( l ) * kernel ( h ) ) + iCH ( l ) * kernel ( l ) & ( 2 )\end{matrix}$$

According to Formula (2), it is indicated that multiplication of 8-bit data using a 4-bit operation unit can be implemented by 4-bit multiplication, a left shift operation, and addition. Since the data processing equipment 1A having the reference accuracy of 8 bits includes four 4-bit operation units, the multiplication of Formula (2) can be collectively performed without performing time division processing if the four 4-bit operation units are used in parallel.

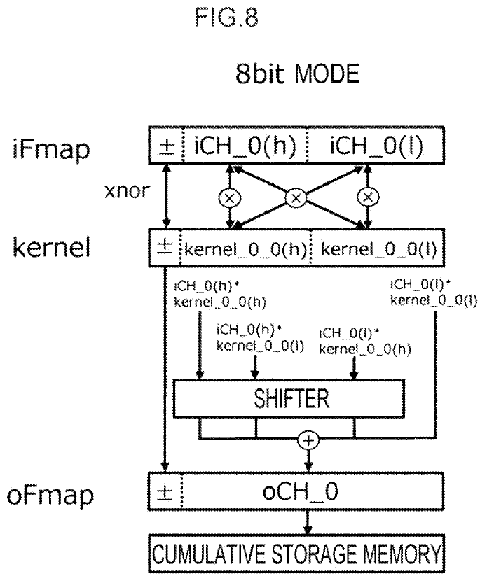

FIG. 8 is a schematic diagram of the 8-bit mode data processing method indicated in Formula (2) using a 4-bit operation unit in a case where the reference accuracy is 8 bits. FIG. 8 illustrates an example of multiplication between an input channel iCH_0 and a kernel_0_0 corresponding to each of the input channel iCH_0 and an output channel oCH_0.

Since the reference accuracy is 8 bits, input data of two channels cannot be processed in parallel in the 8-bit mode as in the 4-bit mode. The data processing equipment 1A performs multiplication of an iFmap and a kernel divided into 4-bit widths using the input channel iCH_0 and the kernel_0_0, a left shift operation, and addition, and stores a cumulative addition of operation results in the cumulative storage memory as an intermediate result of the output channel oCH_0.

By the product-sum operation described above being repeatedly executed for each pixel included in the iFmap of the input channel iCH_0, a final oFmap of the output channel oCH_0 is obtained. Furthermore, by the product-sum operation being repeated for output channels oCH_m, an oFmap in all the output channels oCH is obtained.

As described above, since data with a sign is generally operated in a convolution operation, the most significant bit of input data is allocated to the sign. However, in an 8-bit operation in which upper data and lower data obtained by dividing are combined, the data processing equipment 1A performs processing represented by Formula (2) using a pixel value of an iFmap of an input channel iCH, upper data from which the most significant bit of a kernel is excluded, and lower data without considering a sign for the time being. Then, the data processing equipment 1A performs an xnor operation of the most significant bit that is a sign bit of the iFmap of the input channel iCH and the most significant bit that is a sign bit of the kernel, and outputs the result as a final sign of an oFmap.

### Data Processing Method in 16-Bit Mode

Next, a 16-bit mode data processing method using a 4-bit operation unit in a case where the reference accuracy is 8 bits will be described.

Since the reference accuracy is 8 bits, the bit width of data that can be collectively processed in the data processing equipment 1A is up to 8 bits. Therefore, as described in the first embodiment, the data processing equipment 1A divides a pixel value of a 16-bit iFmap into upper 8 bits and lower 8 bits, divides a kernel value of a 16-bit kernel into upper 8 bits and lower 8 bits, and performs time division processing on each piece of the 8-bit data obtained by dividing in four times from an operation [1] to an operation [4].

However, since the operation units according to the second embodiment are 4-bit operation units, in a case where the data processing equipment 1A operates 8-bit data, the method described in [Data Processing Method in 8-bit Mode] in the second embodiment is used.

As described above, the data processing equipment 1A can perform a convolution operation of input data having a bit width larger than the reference accuracy by repeatedly performing a convolution operation of the reference accuracy.

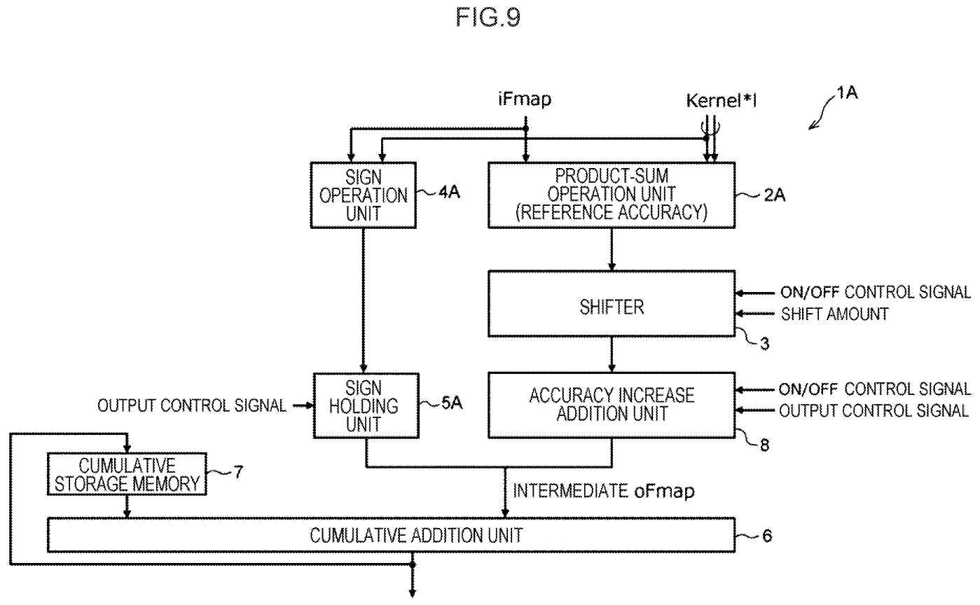

FIG. 9 is a diagram illustrating a functional configuration example of the data processing equipment 1A. The functional configuration example of the data processing equipment 1A illustrated in FIG. 9 is different from the functional configuration example of the data processing equipment 1 according to the first embodiment illustrated in FIG. 3 in that an accuracy increase addition unit 8 is added, and the product-sum operation unit 2, the sign operation unit 4, and the sign holding unit 5 are replaced with a product-sum operation unit 2A, a sign operation unit 4A, and a sign holding unit 5A, respectively.

The product-sum operation unit 2A receives an iFmap and a kernel, and performs a product-sum operation of the reference accuracy using an operation unit of the minimum accuracy.

The sign operation unit 4A determines a sign by performing an xnor operation of the most significant bit that is a sign bit of a pixel value of the iFmap and the most significant bit that is a sign bit of a kernel value, and outputs the sign to the sign holding unit 5A.

The sign holding unit 5A reflects the held sign in an intermediate oFmap output by the accuracy increase addition unit 8 to be described below at a timing when an output control signal is input. Note that the output control signal is input to the sign holding unit 5A at a timing when the accuracy increase addition unit 8 outputs an intermediate oFmap.

The accuracy increase addition unit 8 performs addition for generating an operation result of the reference accuracy from an operation result of the minimum accuracy. Specifically, the accuracy increase addition unit 8 adds operation results of a product-sum operation of the minimum accuracy on which a left shift operation has been performed by a shifter 3 according to a designated shift amount, and generates an operation result of a convolution operation of input data using a multiple bit width that is twice or more of the minimum accuracy (in this case, 8 bits) as the reference accuracy.

Note that, as described above, in a case of the 4-bit mode, the supply amount of kernels needs to be doubled in order to operate output channels OCH in parallel as compared with a case of operating an output channel oCH of one channel. Therefore, the input bit width of a kernel input to the product-sum operation unit 2A and the sign operation unit 4A illustrated in FIG. 9 is twice the input bit width of a kernel of the data processing equipment 1 according to the first embodiment illustrated in FIG. 3. However, if the output channels oCH do not need to be operated in parallel, the input bit width of a kernel input to the product-sum operation unit 2A and the sign operation unit 4A may be the same as the input bit width of a kernel of the data processing equipment 1 according to the first embodiment illustrated in FIG. 3.

Here, as an example, the input bit width of a kernel is twice the bit width of the minimum accuracy, but may be K times the minimum accuracy (K is an integer of 2 or more).

Similarly to the data processing equipment 1 according to the first embodiment, the data processing equipment 1A can also be formed using the computer 10 illustrated in FIG. 4.

Next, the operation of the data processing equipment 1A according to the second embodiment will be described.

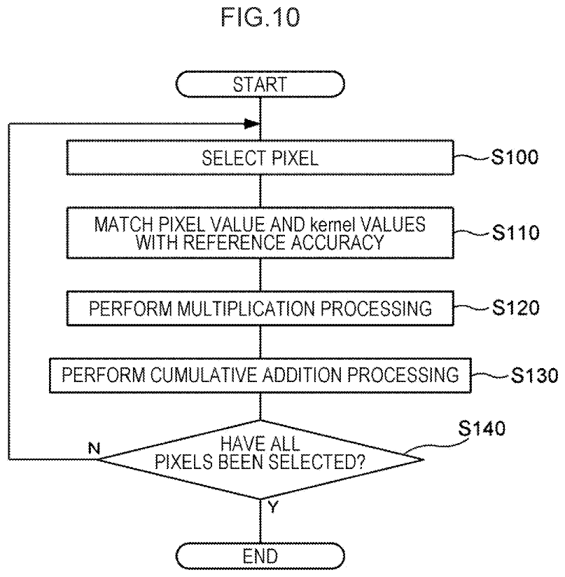

FIG. 10 is a flowchart illustrating an example of a flow of convolution operation processing executed by a CPU 11 of the data processing equipment 1A in the 4-bit mode.

The data processing program defining the convolution operation processing is stored in advance in, for example, an ROM 12 of the data processing equipment 1A. The CPU 11 of the data processing equipment 1A reads the data processing program stored in the ROM 12 and executes convolution operation processing. Note that the CPU 11 initializes a cumulative addition value stored, for example, in an RAM 13 to “0” before executing the convolution operation processing.

When an iFmap of any two channels of input channels iCH_n and kernels of two channels corresponding to the iFmap of each, that is, four kernels_o_i are input, in step S100, the CPU 11 selects any one pixel from the iFmap of each, and acquires a pixel value of the pixel selected from the iFmap of each and a kernel value of a kernel_o_i corresponding to the pixel selected from the iFmap of each. Both the selected pixel value and the kernel value acquired from the kernel_o_i are represented by 4 bits.

Note that, for convenience of description, convolution operation processing illustrated in FIG. 10 will be described below using an example in which an iFmap of iCH_0 and iCH_1, a kernel_0_0, a kernel_1_0, a kernel_0_1, and a kernel_1_1 are input.

Since the reference accuracy of an operation unit in the computer 10 is 8 bits, in step S110, the CPU 11 generates a parallel pixel value having an 8-bit width in which the selected pixel value of iCH_1 is upper 4 bits and the selected pixel value of iCH_0 is lower 4 bits, and two parallel kernel values having an 8-bit width obtained by kernels_o_i including a common output channel oCH, and matches the pixel value and the kernel values with the reference accuracy.

In step S120, the CPU 11 executes multiplication processing of performing a multiplication operation between the upper 4 bits and the lower 4 bits of each of the parallel pixel value and the two parallel kernel values generated in step S110. As a result, multiplication results of “iCH_0*kernel_0_0”, “iCH_0*kernel_1_0”, “iCH_1*kernel_0_1”, and “iCH 1*kernel_1_1” are obtained.

In step S130, the CPU 11 adds terms of multiplication results with a kernel_o_i having the same number of the output channel oCH. As a result, “iCH_0*kernel_0 0+iCH 1*kernel_0_1” and “iCH_0*kernel_1_0+iCH_1*kernel_1_1” are obtained as addition values of multiplication results for respective output channels oCH.

Then, the CPU 11 executes cumulative addition processing of adding the addition values of the multiplication results for the respective output channels oCH to cumulative addition values prepared for the respective output channels oCH.

In step S140, the CPU 11 determines whether all pixels included in the input iFmap of each have been selected. In a case where an unselected pixel is included in the iFmap of each, the processing proceeds to step S100, any one of unselected pixels is selected from the iFmap of each, and processing of steps S100 to S140 is repeatedly executed until all the pixels are selected. On the other hand, in a case where all the pixels included in the iFmap of each are selected, the convolution operation processing in the 4-bit mode illustrated in FIG. 10 is ended.

As described above, the convolution operation of the iFmap and the kernels of two channels is performed, and cumulative addition values obtained by the convolution operation are stored in the RAM 13 as pixel values of an oFmap. In a case where there are n channels of an iFmap, the CPU 11 may repeatedly execute the convolution operation processing illustrated in FIG. 10 until the iFmap of n channels is processed.

Next, convolution operation processing of the data processing equipment 1A in the 8-bit mode will be described.

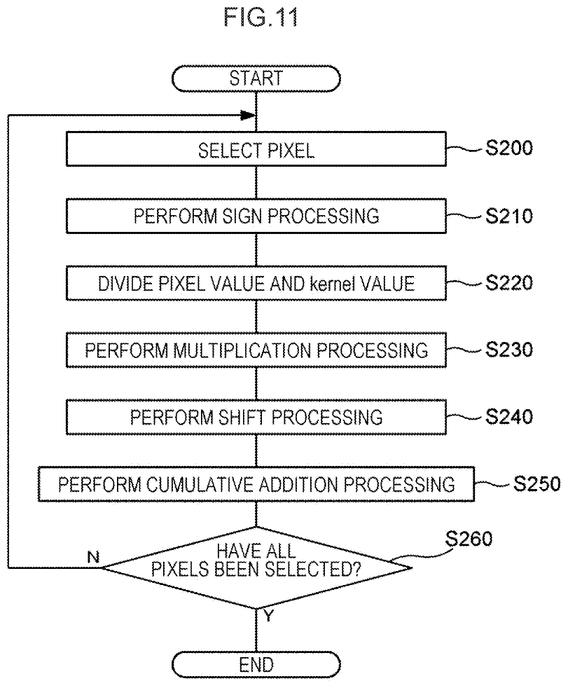

FIG. 11 is a flowchart illustrating an example of a flow of convolution operation processing executed by a CPU 11 of the data processing equipment 1A in the 8-bit mode.

When an iFmap and a kernel of any one of input channels iCH_n are input, in step S200, the CPU 11 selects any one pixel included in the iFmap, and acquires a pixel value of the pixel selected from the iFmap and a kernel value of a kernel corresponding to the pixel selected from the iFmap. Both the selected pixel value acquired from the iFmap and the kernel value acquired from the kernel are represented by 8 bits.

In step S210, the CPU 11 performs an xnor operation of the most significant bit of the selected pixel value and the most significant bit of the kernel value to execute sign processing of determining the sign of an oFmap. The CPU 11 stores the operation result of the xnor operation representing the sign in the RAM 13.

In step S220, the CPU 11 divides the selected pixel value into upper 4 bits and lower 4 bits, and also divides the kernel value into upper 4 bits and lower 4 bits. The upper 4 bits and the lower 4 bits of the divided selected pixel value correspond to “iCH(h)” and “iCH(1)” indicated in Formula (2), respectively. The upper 4 bits and the lower 4 bits of the divided kernel value correspond to “kernel(h)” and “kernel(1)” indicated in Formula (2), respectively.

In step S230, in order to calculate Formula (2), the CPU 11 executes multiplication processing of collectively operating iCH(h)*kernel(h), iCH(h)*kernel(1), iCH(1)*kernel(h), and iCH(1)*kernel(1) using four 4-bit operation units.

In step S240, the CPU 11 executes shift processing of performing a left shift operation by a shift amount uniquely determined from Formula (2) on each multiplication result of a selected pixel value and a kernel value each obtained by dividing. Specifically, the CPU 11 shifts iCH(h)*kernel(h) to the left by about 16 bits, shifts iCH(h)*kernel(1) and iCH(1) * kernel(h) to the left by about 8 bits, and does not perform a left shift operation on iCH(1)*kernel (1).

In step S250, the CPU 11 reflects the sign stored in the RAM 13 in step S210 in a value obtained by adding each operation result subjected to the shift processing in step S240, and executes cumulative addition processing of adding the addition result in which the sign is reflected to a cumulative addition value.

In step S260, the CPU 11 determines whether all pixels included in the input iFmap have been selected. In a case where an unselected pixel is included in the iFmap, the processing proceeds to step S200, any one of unselected pixels is selected, and processing of steps S200 to S260 is repeatedly executed until all the pixels are selected. On the other hand, in a case where all the pixels included in the iFmap are selected, the convolution operation processing in the 8-bit mode illustrated in FIG. 11 is ended.

As described above, the convolution operation of the iFmap and the kernel of one channel is performed, and a cumulative addition value obtained by the convolution operation is stored in the RAM 13 as a pixel value of an oFmap. In a case where there are n channels of an iFmap, the CPU 11 may repeatedly execute the convolution operation processing illustrated in FIG. 11 by the number of input channels.

Note that, for the convolution operation processing of the data processing equipment 1A in the 16-bit mode, the same processing as the convolution operation processing in the 16-bit mode of the data processing equipment 1 according to the first embodiment illustrated in FIG. 5 is required to be performed. Provided that the minimum accuracy of an operation unit of the data processing equipment 1 according to the first embodiment is 8 bits, and the minimum accuracy of an operation unit of the data processing equipment 1A according to the second embodiment is 4 bits. Therefore, in a case where an 8-bit operation is performed on a pixel value of an iFmap and a kernel value of a kernel each divided into 8-bit widths in step S20 of FIG. 5, the 8-bit operation by a 4-bit operation unit is performed by processing illustrated in steps S220 to S250 of FIG. 11.

As described above, according to the data processing equipment 1A according to the second embodiment, an operation of the reference accuracy using an operation unit of the minimum accuracy can be implemented by adding the accuracy increase addition unit 8 to the data processing equipment 1 according to the first embodiment. Furthermore, the data processing equipment 1A can also implement an operation of accuracy higher than the reference accuracy by repeating a convolution operation of the reference accuracy a plurality of times.

Note that the case where the bit width of a pixel value of an iFmap and the bit width of a kernel value are the same has been described in the first embodiment and the second embodiment, but this is an example, and the bit width of a pixel value of an iFmap and the bit width of a kernel value may be different.

Although one form of the data processing equipment 1, 1A has been described above, the disclosed form of the data processing equipment 1, 1A is an example, and the form of the data processing equipment 1, 1A is not limited to the scope described in each embodiment. Various modifications or improvements can be made to each embodiment without departing from the gist of the present disclosure, and the modified or improved form is also included in the technical scope of the disclosure. For example, the internal processing order in the convolution operation processing illustrated in FIGS. 5, 6, 10, and 11 may be changed without departing from the gist of the present disclosure.

In the present disclosure, a form in which the convolution operation processing is implemented by software has been described as an example. However, processing equivalent to that in flowcharts illustrated in FIGS. 5, 6, 10, and 11 may be implemented in, for example, an application specific integrated circuit (ASIC), a field programmable gate array (FPGA), or a programmable logic device (PLD), and may be processed by hardware. In this case, the processing speed is increased as compared with a case where the convolution operation processing is implemented by software.

As described above, the CPU 11 of the data processing equipment 1, 1A may be replaced with a dedicated processor specialized for specific processing, such as an ASIC, an FPGA, a PLD, a graphics processing unit (GPU), or a floating point unit (FPU).

Besides being implemented by one CPU 11, the convolution operation processing may be executed by a combination of two or more processors of the same type or different types, such as a plurality of CPUs 11 or a combination of the CPU 11 and the FPGA.

Furthermore, the convolution operation processing may be implemented, for example, by cooperation of processors physically apart from each other and connected via the Internet.

In each embodiment, an example in which the data processing program is stored in the ROM 12 of the data processing equipment 1, 1A has been described, but the storage destination of the data processing program is not limited to the ROM 12. The data processing program of the present disclosure can also be provided in a form of being recorded in a storage medium readable by the computer 10. For example, the data processing program may be provided in a form of being recorded on an optical disk such as a compact disk read only memory (CD-ROM) or a digital versatile disk read only memory (DVD-ROM). Alternatively, the data processing program may be provided in a form of being recorded in a portable semiconductor memory such as a universal serial bus (USB) memory or a memory card.

The ROM 12, the storage 14, the CD-ROM, the DVD-ROM, the USB, and the memory card are examples of a non-transitory storage medium.

Further, the data processing equipment 1, 1A may download the data processing program from an external device through the communication I/F 17 and store the downloaded data processing program in the storage 14, for example. In this case, the data processing equipment 1, 1A reads the data processing program downloaded from the external device and executes the convolution operation processing.

All documents, patent applications, and technical standards described in this specification are incorporated herein by reference to the same extent as in a case where a case where incorporation by reference of each document, patent application, and technical standard is specifically and individually described.

Regarding the embodiments described above, the following supplements are further disclosed.

### Supplement 1

A data processing equipment that performs a convolution operation on two items of input data having a width of 2^{M}*N-bit, where N is a positive integer and M is an integer of 0 or more, with a minimum accuracy of a convolution operation being N bits, and performs processing corresponding to a plurality of the Ms that are consecutive, the data processing equipment including:
a memory; and
at least one processor connected to the memory,
in which the processor
performs a product-sum operation of the minimum accuracy,
performs shift processing on an operation result of a product-sum operation of the minimum accuracy in a case in which a value of the M is not 0,
performs an operation of a sign in a convolution operation of the input data in a case in which a value of the M is not 0,
holds an operated sign until a reset signal of which notice is given every time a convolution operation of the input data is ended is received, and reflects a held sign in an output of shift processing according to a value of the M,
cumulatively adds an output of shift processing in which a sign is reflected, and
stores an operation result of cumulative addition acquired in a process of a convolution operation in the memory.

### Supplement 2

A non-transitory storage medium that stores a data processing program executable by a computer so that data processing of performing a convolution operation on two items of input data having a width of 2^{M}*N-bit, whereN is a positive integer and M is an integer of 0 or more, with a minimum accuracy of a convolution operation being N bits, and performing processing corresponding to a plurality of the Ms that are consecutive is executed,
in which the data processing includes
performing a product-sum operation of the minimum accuracy,
performs shift processing on an operation result of a product-sum operation of the minimum accuracy in a case in which a value of the M is not 0,
performing an operation of a sign in a convolution operation of the input data in a case in which a value of the Mis not 0,
holding an operated sign until a reset signal of which notice is given every time a convolution operation of the input data is ended is received, and reflecting a held sign in an output of shift processing according to a value of the M,
cumulatively adding an output of shift processing in which a sign is reflected, and
storing an operation result of cumulative addition acquired in a process of a convolution operation in the memory.

1. A data processing equipment that performs a convolution operation on two items of input data having a width of 2^{M}*N-bit, where N is a positive integer and M is an integer of 0 or more, with a minimum accuracy of a convolution operation being N bits, and performs processing corresponding to a plurality of the Ms that are consecutive, the data processing equipment comprising:
a memory; and
at least one processor connected to the memory, the processor being configured to:
perform a product-sum operation of the minimum accuracy,
perform shift processing on an operation result of a product-sum operation of the minimum accuracy in a case in which a value of the M is not 0,
perform an operation of a sign in a convolution operation of the input data in a case in which a value of the M is not 0,
hold an operated sign until a reset signal, of which notice is given every time a convolution operation of the input data is ended, is received, and reflect a held sign in an output of shift processing according to a value of the M,
cumulatively add an output of shift processing in which a sign is reflected, and
store an operation result of cumulative addition acquired in a process of a convolution operation in the memory.

2. The data processing equipment according to claim 1, wherein the processor:
performs a convolution operation of the input data by repeating a product-sum operation of the minimum accuracy a predetermined number of times according to a value of the M, and
performs a left shift operation on an operation result of a product-sum operation of the minimum accuracy according to a shift amount set in advance according to a combination of operation targets of a product-sum operation of the minimum accuracy repeatedly performed on a convolution operation of the input data.

3. The data processing equipment according to claim 2, wherein, in a case of performing a convolution operation on each item of the input data, the product-sum operation unit the processor first performs a product-sum operation of N-bit units positioned at an uppermost order of each item of the input data on each item of the input data divided into N-bit units.

4. The data processing equipment according to claim 2 , wherein the processor adds each operation result of a product-sum operation of the minimum accuracy on which a left shift operation has been performed according to the shift amount, and generates an operation result of a convolution operation of the input data, using a multiple bit width that is twice or more of the minimum accuracy, as reference accuracy.

5. The data processing equipment according to claim 4, wherein the processor performs a convolution operation of the input data having a bit width larger than the reference accuracy by repeatedly performing a convolution operation of the reference accuracy.

6. The data processing equipment according to claim 5, wherein:
one item of the input data is data related to an image, and another item of the input data is a kernel that extracts a feature of the image, and
an input bit width of the kernel input to a product-sum operation and a sign operation is K times a bit width of the minimum accuracy, where K is an integer of 2 or more.

7. A non-transitory storage medium that stores a data processing program executable by a computer to perform data processing of performing a convolution operation on two items of input data having a width of 2^{M}*N-bit, where N is a positive integer and M is an integer of 0 or more, with a minimum accuracy of a convolution operation being N bits, and performing processing corresponding to a plurality of the Ms that are consecutive, the data processing comprising:
performing a product-sum operation of the minimum accuracy;
performing shift processing on an operation result of a product-sum operation of the minimum accuracy in a case in which a value of the M is not 0;
performing an operation of a sign in a convolution operation of the input data in a case in which a value of the M is not 0;
holding an operated sign until a reset signal, of which notice is given every time a convolution operation of the input data is ended, is received, and reflecting a held sign in an output of the shift processing according to a value of the M;
cumulatively adding an output of the shift processing in which a sign is reflected; and
storing an operation result of cumulative addition acquired in a process of a convolution operation.

8. A data processing method of performing a convolution operation on two items of input data having a width of 2^{M}*N-bit, where N is a positive integer and M is an integer of 0 or more, with a minimum accuracy of a convolution operation being N bits, and performing processing corresponding to a plurality of the Ms that are consecutive, the method comprising a computer executing processing comprising:
performing a product-sum operation of the minimum accuracy;
performing shift processing on an operation result of a product-sum operation of the minimum accuracy in a case in which a value of the Mis not 0;
performing an operation of a sign in a convolution operation of the input data in a case in which a value of the M is not 0;
holding an operated sign until a reset signal, of which notice is given every time a convolution operation of the input data is ended, is received, and reflecting a held sign in an output of the shift processing according to a value of the M;
cumulatively adding an output of the shift processing in which a sign is reflected; and
storing an operation result of cumulative addition acquired in a process of a convolution operation.
